(19) United States
(12) Patent Application Publication
(10) Pub. No.: US 2015/0328847 A1
(43) Pub. Date: Nov. 19, 2015

(54) POLYMERIC COMPOSITE REPAIR VIA RADIOFREQUENCY HEATING OF MAGNETIC PARTICLES

(71) Applicant: GM Global Technology Operations LLC, Detroit, MI (US)

(72) Inventors: Hamid G. KIA, Bloomfield Hills, MI (US); Xiaosong HUANG, Novi, MI (US)

(73) Assignee: GM Global Technology Operations LLC, Detroit, MI (US)

(21) Appl. No.: 14/278,625

(22) Filed: May 15, 2014

(51) Int. Cl. B29C 73/02; B29C 73/34; B29C 73/30

(52) U.S. Cl. CPC B29C 73/02; B29C 73/30; B29C 73/34

(57) ABSTRACT

A method of repairing a polymeric composite workpiece. The method includes detecting and identifying a localized area of a polymeric composite workpiece having a defect. A resin is applied to the localized area. The resin includes a plurality of magnetic particles dispersed therein. The resin may include a mixture of nanoparticles dispersed therein, selected from the group consisting of a thermosetting resin, a thermoplastic resin, and mixtures thereof. The method includes introducing radiofrequency electromagnetic radiation adjacent the resin to selectively induce localized heating and/or curing of the resin.

### FIELD

The present disclosure relates to methods of repairing polymeric composite parts using radiofrequency heating of magnetic particles in a resin or binder.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present technology.

The bodies of motor vehicles must manage the loads applied both during normal vehicle service and under extraordinary conditions such as a collision. Increasingly, vehicle bodies are constructed using materials such as polymer-based composites that offer higher strength to weight ratios than the low strength, low carbon steel used in older designs. Polymeric composites in particular have been widely used in automobiles, and their utilization is expected to continue increasing in the future in an effort to further reduce the vehicle mass. Accordingly, the development of an effective repair method for impact damaged composite structures will remain important.

Automobile parts such as panels and bumpers made from polymer composites are preferably designed to resist damage from low speed collisions, impacts from small stones or objects, and the weight of a leaning person. With higher energy impacts, however, various scuffs, dents, cracks, and other defects or damage can be formed in the panels and bumpers. Given certain part shapes, dimensions, or the assembly technologies, it is sometimes less expensive to replace a component than repair it. In most other circumstances, repairing a damaged component would be desirable. Accordingly, there remains a need for improved repair techniques for polymer composites.

### SUMMARY

This section provides a general summary of the disclosure, and is not a comprehensive disclosure of its full scope or all of its features.

In various aspects, the present teachings provide a method for repairing a polymeric composite workpiece. The method includes identifying a localized area of a polymeric composite workpiece having at least one defect. A resin is applied to the localized area. The resin includes a plurality of magnetic particles dispersed therein, which may include a mixture of nanoparticles. In various aspects, the resin may be selected from the group consisting of a thermosetting resin, a thermoplastic resin, and mixtures thereof. The method includes introducing radiofrequency electromagnetic radiation adjacent the resin to selectively induce localized heating and/or curing of the resin.

In other aspects, the method for repairing the polymeric composite workpiece includes identifying a localized area of a polymeric composite workpiece having at least one defect and applying a resin to the localized area. The resin includes a plurality of magnetic particles dispersed therein. The method includes covering at least a portion of the polymeric composite workpiece and the localized area with a vacuum bag foil layer. A vacuum bagging technique is applied to form a vacuum sealed enclosure including the localized area. Radiofrequency electromagnetic radiation is introduced adjacent the vacuum sealed enclosure to selectively induce localized heating and/or curing of the resin.

In still other aspects, the present teachings provide a method of repairing a layered polymeric composite workpiece using a stepped or scarf repair technique. The method includes identifying a localized area of a layered polymeric composite workpiece having at least one defect. A tapered work area is prepared encompassing the defect and having a plurality of stepped ply layer openings (or an opening with a beveled edge for scarf repair) configured to receive a plurality of equivalently sized replacement ply layer portions. A resin including a plurality of magnetic particles dispersed therein is applied to the tapered work area with at least one of the plurality of replacement ply layer portions. The method includes introducing radiofrequency electromagnetic radiation adjacent the tapered work area to selectively induce localized heating and/or curing of the resin.

Further areas of applicability and various methods will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIGS. 1A, 1B, and 1C illustrate a polymeric composite structure having a non-structural defect repaired using the techniques of the present disclosure;

FIGS. 2A, 2B, and 2C illustrate a polymeric composite structure having a structural defect/crack repaired using the techniques of the present disclosure; and

FIGS. 3A and 3B illustrate a layered polymeric composite structure having a non-structural defect repaired using a stepped repair technique of the present disclosure.

It should be noted that the figures set forth herein are intended to exemplify the general characteristics of materials, methods, and devices among those of the present technology, for the purpose of the description of certain aspects. These figures may not precisely reflect the characteristics of any given aspect, and are not necessarily intended to define or limit specific embodiments within the scope of this technology. Further, certain aspects may incorporate features from a combination of figures.

### DETAILED DESCRIPTION

The following description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Spatially relative terms, such as “inner,” “outer,” “beneath,” “below,” “lower,” “above,” “upper,” “on,” and their variants, may be used herein for ease of description to describe one element or feature's relationship to another element(s) or feature(s). Spatially relative terms may encompass different orientations of the device in use or operation. As used herein, when a coating, layer, or material is “applied onto,” “applied over,” “formed on,” “deposited on,” etc. another substrate or item, the added coating, layer, or material may be applied, formed, deposited on an entirety of the substrate or item, or on at least a portion of the substrate or item.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims.

The present disclosure relates to methods of repairing polymeric composite parts using radiofrequency (RF) heating of magnetic (e.g. ferromagnetic or superparamagnetic) particles. In general, magnetic particles generate heat under an external AC magnetic field by several physical mechanisms: relax loss or hysteresis loss, which may strongly depend on the particle shape as well as the frequency of the external field. More particularly, the present technology relates to using radiofrequency or dielectric heating of magnetic or conductive particles dispersed within a resin to provide localized heating for the curing or reforming of the resin, and the repair and recovery of damaged polymeric composite structures.

Polymeric composite parts, such as components and workpieces for an automobile, can be damaged during normal use or as a result of collisions with foreign objects. The damage may be non-structural in nature (scuffs, dents, surface cracks, interface cracking, sub-interface cracking, debonding, delamination, etc.) or structural (deep or complete cracks through the component). Depending on the type of damage or defect, a binder, such as a resin, can be used to repair the component or workpiece, for example, by filling in or covering the damage or defect. Depending on the particular resin used, the time required for the resin to cure can vary, up to 48 hours or longer in certain circumstances. Increased time generally results in increased costs of repair. The application of heat typically decreases the cure time of the resin. However, it may not be desirable to heat the adjacent portions of the composite part due to the potential for deformation or damage of the part from the heat.

The present disclosure teaches the use of magnetic and/or conductive particles dispersed within the binder or resin. As is known in the art, when an alternating magnetic field is introduced and applied, magnetic materials are observed to heat as a result of losses occurring due to the internal rotation of the magnetization and rotation of the magnetic particles in a viscous medium. The conductive particles generate heat due to the induced eddy currents. The radiofrequency response of the magnetic or conductive particles can uniformly heat the target resin area without auxiliary heating of adjacent areas. This can significantly simplify and/or minimize the need and design of heating units that have commonly been used for composite repair.

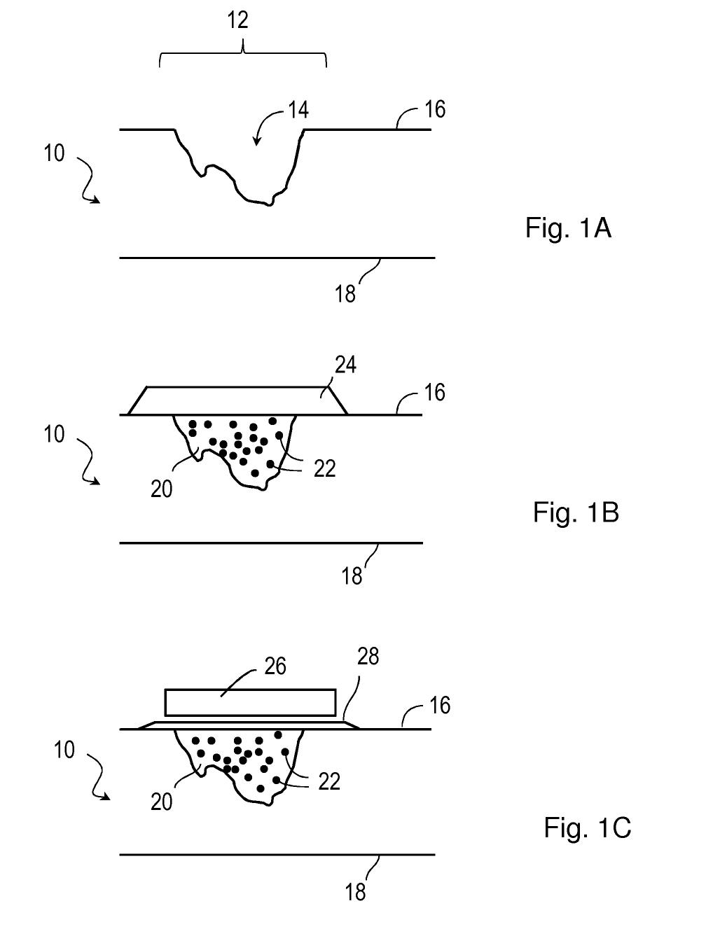

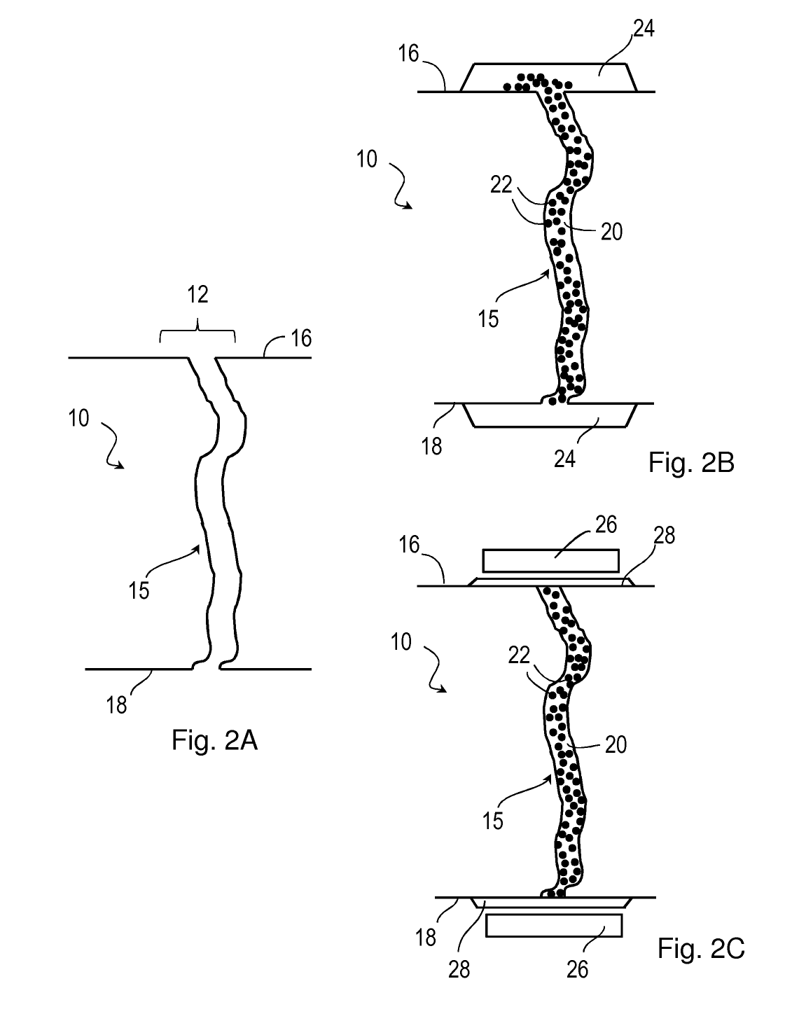

FIGS. 1A, 1B, and 1C illustrate a polymeric composite structure having a non-structural defect that may be repaired using the techniques of the present disclosure. As shown in FIG. 1A, the polymeric composite workpiece 10 has a localized area 12 having at least one non-structural defect 14 or damaged area on the front-facing major surface 16 of the workpiece. A non-structural defect 14 may, for example, have a depth of from about 0.1 mm to about 4 mm, or greater, depending on the thickness and end use of the workpiece. FIGS. 2A, 2B, and 2C illustrate a polymeric composite structure having a structural defect 15 that may be repaired using the techniques of the present disclosure. As shown in FIG. 2A, the structural defect 15 or damaged area, such as a crack, may extend from the front-facing major surface 16 to the opposing rear-facing major surface 18 of the workpiece 10.

As will be discussed in more detail below, for the repair of polymeric composite parts, structures, or workpieces containing thermoset materials, an uncured resin containing magnetic particles may be applied to the defect in liquid form that is subsequently cured when an appropriate radiofrequency electromagnetic radiation is applied. For the repair of polymeric composite parts, structures, or workpieces containing thermoplastic materials, a resin containing magnetic particles may be applied to the defect in the form of a viscous liquid or putty that is subsequently cured or reformed when an appropriate radiofrequency electromagnetic radiation is applied. Thus, the resin may include a thermosetting resin, a thermoplastic resin, and mixtures or combinations thereof. In certain aspects, the resin may comprise an adhesive, such as a liquid epoxy based adhesive, a methacrylate based adhesive, a urethane based adhesive, an acrylic based adhesive, or the like, including mixtures or combinations thereof. Examples of commercially available adhesives include PLEXUS® MA530 (a two-part methacrylate adhesive designed for structural bonding of thermoplastic, metal, and composite assemblies) available from ITW PLEXUS in Danvers, Mass.; and PLIOFRIP® 7770B (a two-part urethane adhesive system designed for structural bonding of thermoplastic, metal, and composite assemblies) available from Ashland Inc. in Covington, Ky.

The methods of the present disclosure include detecting and identifying a localized area 12 of a polymeric composite workpiece 10 having a defect 14 such as a scuff, dent, or surface crack. In most instances, the defect can be discovered with the naked eye or non-destructive evaluation techniques, such as vibrothermography, pulse thermography, phased array ultrasound, etc. With reference to FIG. 1B, the methods of the present disclosure include applying a resin 20 to the localized area 12 covering or filling any defect 14 present. In certain aspects, a textured mold can be placed on the top of the resin to recover the surface texture of the composite part. As discussed above, the resin 20 may include a plurality of magnetic particles 22 uniformly dispersed therein.

The magnetic particles 22 may be ferromagnetic and blended with the resin in such a manner to substantially minimize clumping or aggregation of the particles in order to achieve a generally uniform particle dispersion in the resin. It is envisioned that any of the classes of ferromagnetic materials may be used, including without limitation: metals such as iron, nickel, or cobalt; alloys and compounds such as those based on neodymium, iron, samarium, and cobalt, as well as Alnico; and oxides including iron oxide and ferrites. Where it may be required to minimize any remnant magnetism, magnetically soft materials, such as substantially pure iron, iron oxide (hematite and magnetite), and soft ferrites such as, for example, manganese-zinc ferrite (MnₐZn₍₁₋ₐ₎Fe₂O₄) or nickel-zinc ferrite (NiₐZn₍₁₋ₐ₎Fe₂O₄) may be employed. Particles of magnetically soft materials may also be employed in combination with one another or other materials. In various aspects, the magnetic particles 22 may include nanoparticles exhibiting magnetic behavior. In presently preferred aspects, the magnetic particles or nanoparticles may include Fe₃O₄, FeCo, carbon nanotubes, and mixtures thereof. In various aspects, the magnetic particles or nanoparticles may be present in an amount of from about 0.1 wt % to about 20 wt % of the resin, from about 0.1 wt % to about 10 wt % of the resin, from about 1 wt % to about 5 wt % of the resin, or from about 1 wt % to about 2 wt % of the resin. Generally, the magnetic particle size useful with the present disclosure may range having an average particle size of from about 10 nm to about 100 μm, or from about 100 nm to about 10 μm. As used herein, the term nanoparticle may include both particles having an average particle size of about 250 nm or less, and particles having an average particle size of greater than about 250 nm to less than about 1 μm, sometimes referred in the art as “sub-micron sized” particles. The magnetic particles may be monodisperse, where all particles are of the same size with little variation, or polydisperse, where the particles have a range of sizes and are averaged.

After the resin is applied, the methods of the present disclosure provide for the introduction of radiofrequency electromagnetic radiation adjacent the resin to selectively include localized heating and curing of the resin. Dielectric heating or induction heating of ferromagnetic and conductive materials can occur when these materials are exposed to an alternating electromagnetic field operating in the kilohertz to megahertz frequency range. As is known in the art, radiofrequency (RF) is a rate of oscillation in the range of from about 3 kHz to about 300 MHz, which corresponds to the frequency of radio waves, and the alternating currents that carry radio signals. By way of example, when using certain ferromagnetic magnetic particles, the radiofrequency electromagnetic radiation may be introduced having a frequency of from about 50 kHz to about 450 kHz, from about 250 kHz to about 300 kHz, or about 280 kHz. In other examples, when using certain nanotube particles, such as carbon nanotubes that have subsequently been magnetized, the radiofrequency electromagnetic radiation may be introduced having a frequency of from about 1 MHz to about 20 MHz, from about 5 MHz to about 15 MHz, or about 13 MHz. The specific radiofrequency or ranges of radiofrequency necessary for the magnetic particles to induce heat may vary upon the composition, particle size, depth of material, etc. See, e.g., He, Z., Satarkar, N., Xie, T., Cheng, Y.-T. and Hilt, J. Z. (2011), Remote Controlled Multishape Polymer Nanocomposites with Selective Radiofrequency Actuations. Adv. Mater., 23: 3192-3196. In various aspects, the radiofrequency electromagnetic radiation may be applied to the localized area and/or resin for a time period of from about 1 minute to about 45 minutes, from about 10 minutes to about 35 minutes, or from about 15 minutes to about 25 minutes. As should be understood, the time may vary depending on the resin composition and the particular magnetic particles selected for use. In certain aspects, the radiofrequency electromagnetic radiation may be applied for a time period sufficient to reach a certain temperature. For example, the radiofrequency electromagnetic radiation may be applied until the localized heating increases a temperature of the resin or localized area to a range of from about 60° C. to about 250° C., from about 75° C. to about 135° C., or from about 90° C. to about 120° C.

As should be understood, the resin composition and magnetic material varieties should be selected with the workpiece composition in mind. For example, where the polymeric composite workpiece comprises a thermoplastic material, it is beneficial to select the resin composition and magnetic material that will be heated to an appropriate temperature such that the region of the polymeric composite workpiece surrounding the defect remains at a temperature lower than a melting temperature of the thermoplastic.

In certain aspects, it may be beneficial to apply two or more different resins, each having a different composition of resin, different composition of magnetic particle material, or both, such that the particle loaded resins will cure and/or reform at different temperatures and/or radiofrequencies. In this regard, the methods may include applying a first layer or amount of resin having a first composition to the defect or localized area, and applying a second layer or amount of resin having a second composition either onto the first composition or onto a different region of the defect or localized area. This would allow for the first composition to cure or reform when subjected to a first radiofrequency level, and the second composition to cure or reform when subjected to a second radiofrequency level, different from the first radiofrequency level.

In certain aspects, it may also be desirable to prepare the resin(s) with a pigment or colorant filler to impart a final color that may correspond better with a color of the workpiece. In addition to the pigment or colorant, the resin compositions of the present technology may comprise optional materials such as a functional filler or other additional agents or additives. As referred to herein, a “functional filler” is a material that is operable to improve one or more properties of the composition. Such properties include one or more chemical or physical properties related to the formulation, function, or utility of the composition, such as physical characteristics, performance characteristics, applicability to specific end-use devices, applications, or environments, ease of manufacturing the composition, and ease of use or processing the composition after its manufacture. For example, stabilizers, wetting agents, rheology control agents, organic and inorganic fillers, dispersing agents, adhesives, adhesion promoters, curing accelerators, tackifiers, waxes, de-aerators, mixtures thereof, and the like as known to those skilled in the art of resin formulations may be included and are contemplated as within the scope of the present technology. While certain additives may be known to exist in the prior art, the amount used with the present technology should be controlled to avoid adverse effects on the workpiece. These additives may be added to the composition at various times, and may also be pre-mixed as group or additive package. In various aspects, functional fillers may be added that allow the resin(s) to form a protective coating layer to improve the abrasion resistance and UV protection of the workpiece.

Air bubbles and wrinkles may need to be worked out and removed to ensure proper wetting of the resin on the surfaces of the workpiece. With renewed reference to FIGS. 1B and 2B, various aspects of the present technology may cure or reform the resin in combination with the use of vacuum sealed area in order to assist in the establishment of a uniformly distributed compression of the resin and/or the complete wetting of the scuff/crack surface and the removal of the air bubbles before and during cure. One non-limiting technique of creating a vacuum sealed area is by using vacuum bagging technology. Thus, the methods may include covering at least a portion of the polymeric composite workpiece and the localized area with a vacuum bag foil layer 24 after applying the resin. An area of negative pressure can subsequently be created through the application of a vacuum bagging technique to form a vacuum sealed enclosure 28 including the localized area as shown in FIGS. 1C and 2C. The methods of the present disclosure include introducing radiofrequency electromagnetic radiation adjacent the vacuum sealed enclosure 28 to selectively induce localized heating and curing or reforming of the resin. As shown in FIGS. 1C and 2C, in certain aspects it may also be desirable to use a heating unit 26 such as a heating blanket or heating plate, optionally shaped commensurate with the workpiece, to provide a secondary source of heat in addition to the radiofrequency heating. In still other aspects, it may be desirable to incorporate a two-step process in which a first resin is applied and cured using radiofrequency heating under a first vacuum pressure, and a second resin is applied and cured using radiofrequency heating under a second vacuum pressure.

With reference to FIGS. 2A-2C, where the defect includes a crack 15 or other defect or damage that extends between both the front- and rear-facing major surfaces 16, 18 of the workpiece 10, the resin may preferably be applied to the front-facing surface 16 of the workpiece 10. Both the front-facing and rear-facing major surfaces 16, 18 may be covered with a vacuum bag foil layer 26 as shown in FIG. 2B. In order of sequence, it may be desirable to apply a vacuum to the rear-facing major surface 18 first, followed by applying a vacuum to the front-facing major surface 16. With the vacuum applied in this manner, it may ensure a complete distribution of resin throughout the defect 15. The radiofrequency electromagnetic radiation may be applied to both vacuum sealed enclosures 28 the front-facing and rear-facing major surfaces 16, 18 at the same time, or in series. Optional heating units 26 may also be provided, as discussed above with reference to FIG. 1C.

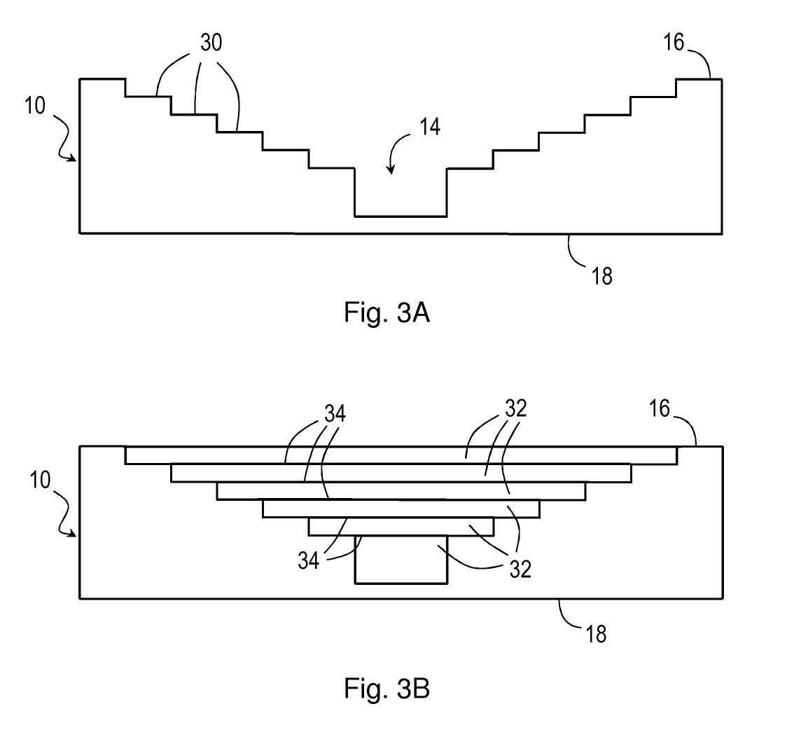

With reference to FIGS. 3A and 3B, if the damaged polymer composite workpiece is a laminated structure, one or more laminate ply portions may be removed and patched using what is known as a “scarf.” The so-called “scarf repair” method, or stepped repair technique, may include preparing a tapered work area, or an opening with a beveled edge for scarf repair, by removing material from a localized area adjacent to and encompassing the defect 14 or damaged area of the workpiece 10 in order to create a hollowed-out area 36 within the laminated structure. In various aspects it may be desired to have a tapered area having a scarf-ratio of about 10:1 to about 60:1. Material is typically removed leaving a bevel or steps of ply layers. For example, linearly extending stepped ply layer openings 30 may be left that are configured to receive a plurality of equivalently sized replacement ply layer portions 32 added during a subsequent stage.

In certain aspects, the replacement ply layer portions 32 can include what are typically referred to as thermoplastic or thermoset “prepregs,” or composite reinforcements, optionally including carbon or other reinforcing fibers, which are pre-impregnated with resin. In accordance with the present teachings, at least one of the plurality of replacement ply layer portions, or prepregs, may be provided with magnetic particles dispersed therein. The selection of the magnetic particles and resins discussed above is similarly applicable with the instant stepped repair technique. The magnetic particles may be dispersed throughout the resin of the prepreg or otherwise dispersed throughout the replacement ply layer portions. In various aspects, the prepregs may be pre-cured or semi-cured. It may also be desirable to use at least two different types of prepregs, for example, that may respond (i.e., induce heat) at different radiofrequencies of electromagnetic radiation.

As shown in FIG. 3B, the replacement ply layer portions 32 may be stacked upon one another in series of increasing size and may include layers 34 of resin there between to serve as a glue or adhesive between replacement ply layer portions 32. The layers 34 of resin may also contain magnetic particles. Accordingly, the methods of the present disclosure may include applying at least one layer of the resin 34 having the magnetic particles between two adjacent replacement ply layer portions 32, which may optionally also include a resin and/or magnetic particles of a different composition. In this regard, the resin layer(s) 34 may be cured or reformed at a first radiofrequency, and at least one replacement ply layer (also comprising a resin or magnetic particles dispersed therein) may be cured or reformed at a second radiofrequency different than the first radiofrequency. It is envisioned that this may be beneficial when it is desirable to apply external pressure during the stepped repair. In one example, the resin layer 34 may be cured/pre-cured or reformed first, bonding adjacent replacement ply layers 32 together. Once the resin layer 34 is cured or at least semi-cured or reformed, external pressure can be applied to the replacement ply layer portions 32, followed by the introduction of radiofrequency electromagnetic radiation in order to cure or reform the replacement ply layers while the external pressure is applied. In various aspects, the external pressure may be from about 0.01 kPa to about 10 MPa.

It should be understood that the present technology is not dependent on, nor limited to, any particular type of material or production method, and the materials and methods may be varied as desired, based on the intended results.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of repairing a polymeric composite workpiece, comprising:
identifying a localized area of a polymeric composite workpiece having at least one defect;
applying a resin to the localized area, the resin comprising a plurality of magnetic particles dispersed therein;
introducing radiofrequency electromagnetic radiation adjacent the resin to selectively induce localized heating and curing of the resin.

2. The method according to claim 1, wherein the resin comprises a mixture of magnetic particles having an average particle size of from about 100 nm to about 10 μm dispersed in a resin selected from the group consisting of a thermosetting resin, a thermoplastic resin, and mixtures thereof.

3. The method according to claim 2, wherein the resin comprises an adhesive selected from the group consisting of a liquid epoxy, a urethane based adhesive, a methacrylate based adhesive, an acrylic based adhesive, and mixtures thereof.

4. The method according to claim 2, wherein the magnetic particles are selected from the group consisting of Fe₃O₄, FeCo, carbon nanotubes, and mixtures thereof.

5. The method according to claim 2, wherein the magnetic particles are present in an amount of from about 1 wt % to about 5 wt % of the resin.

6. The method according to claim 1, wherein the radiofrequency electromagnetic radiation is introduced having a frequency of from about 250 kHz to about 15 MHz for a time period of from about 1 minutes to about 25 minutes.

7. The method according to claim 6, wherein the localized heating increases a temperature of the resin to a range of from about 90° C. to about 120° C.

8. The method according to claim 1, wherein applying the resin to the localized area comprises:
applying a first layer of uncured resin having a first composition to the localized area; and
applying a second layer of uncured resin having a second composition to the localized area,
wherein the first composition cures when subjected to a first radiofrequency level, and the second composition cures when subjected to a second radiofrequency level.

9. The method according to claim 1, wherein the polymeric composite workpiece comprises a thermoplastic material and a region of the polymeric composite workpiece surrounding the defect remains at a temperature lower than a melting temperature of the thermoplastic.

10. The method according to claim 1, wherein the resin comprises at least one pigment filler.

11. A method of repairing a polymeric composite workpiece, comprising:
identifying a localized area of a polymeric composite workpiece having at least one defect;
applying a resin to the localized area, the resin comprising a plurality of magnetic particles dispersed therein;
covering at least a portion of the polymeric composite workpiece and the localized area with a vacuum bag foil layer;
applying a vacuum bagging technique to form a vacuum sealed enclosure including the localized area;
introducing radiofrequency electromagnetic radiation adjacent the vacuum sealed enclosure to selectively induce localized heating or curing of the resin.

12. The method according to claim 11, wherein the polymeric composite workpiece defines opposing front-facing and rear-facing major surfaces, and the defect comprises a structural crack extending from the front-facing major surface to the rear-facing major surface.

13. The method according to claim 12, comprising:
applying the resin to the front-facing major surface of the polymeric composite workpiece;
covering both the front-facing and rear-facing major surfaces of the polymeric composite workpiece with a vacuum bag foil layer;
applying a vacuum to the rear-facing major surface, followed by applying a vacuum to the front-facing major surface; and
introducing the radiofrequency electromagnetic radiation to the front-facing and rear-facing major surfaces.

14. The method according to claim 11, further comprising placing a heating unit adjacent one or both major surfaces near the localized area.

15. The method according to claim 11, wherein the resin comprises a mixture of nanoparticles dispersed in a resin selected from the group consisting of a thermosetting resin, a thermoplastic resin, and mixtures thereof.

16. The method according to claim 11, wherein the magnetic particles comprise nanoparticles selected from the group consisting of Fe₃O₄, FeCo, carbon nanotubes, and mixtures thereof; and the nanoparticles are present in an amount of from about 1 wt % to about 5 wt % of the resin.

17. A method of repairing a layered polymeric composite workpiece using a stepped repair or scarf repair technique, the method comprising:
identifying a localized area of a polymeric composite workpiece having at least one defect;
preparing a tapered work area encompassing the defect, the tapered work area having a plurality of stepped ply layer openings configured to receive a plurality of equivalently sized replacement ply layer portions;
applying a resin comprising a plurality of magnetic particles dispersed therein to the tapered work area with at least one of the plurality of replacement ply layer portions;
introducing radiofrequency electromagnetic radiation adjacent the tapered work area to selectively induce localized heating or curing of the resin.

18. The method according to claim 17, wherein at least one of the plurality of replacement ply layer portions is provided with magnetic particles dispersed therein.

19. The method according to claim 18, comprising applying at least one layer of the resin between two adjacent replacement ply layers, wherein the resin is cured at a first radiofrequency, and the at least one replacement ply layer comprising the magnetic particles dispersed therein is cured at a second radiofrequency.

20. The method according to claim 19, comprising:
pre-curing the at least one layer of resin;
applying an external pressure to the replacement ply layers; and
curing the replacement ply layers while applying the external pressure.
